(19) United States
(12) Patent Application Publication
(10) Pub. No.: US 2014/0239133 A1
(43) Pub. Date: Aug. 28, 2014

(54) Universal Stand for Monitors

(71) Applicant: Atlantic Representations, Inc., Santa Fe Springs, CA (US)

(72) Inventors: Don Burns, Cerritos, CA (US); Glenn Hamilton, Winchester, KY (US)

(73) Assignee: Atlantic Representations, Inc., Santa Fe Springs, CA (US)

(21) Appl. No.: 14/189,834

(22) Filed: Feb. 25, 2014

Related U.S. Application Data
(60) Provisional application No. 61/769,028, filed on Feb. 25, 2013.

(51) Int. Cl. F16M 11/04

(52) U.S. Cl. CPC F16M 11/04
USPC 248/121

(57) ABSTRACT

A universal flat screen TV stand, comprising a foot, a leg connected to the foot, and a bracket connected to the leg and configured to attach to almost any monitor.

### CROSS-REFERENCE TO RELATED APPLICATIONS

This patent application claims the benefit of U.S. Provisional Patent Application Ser. No. 61/769,028, emitted “Universal Base for Plat Screen TV/” filed Feb. 25, 2013, which application is incorporated in its entirety here by this reference.

### TECHNICAL FIELD

This invention relates to stands for monitors, such as television, computer monitors, and the like.

### BACKGROUND

Televisions have moved away from the large, cumbersome cathode ray tube styles and into the relatively lightweight LED or plasma flat screen styles. With this transition came an onslaught of various television stands and mounts to allow the lighter, thinner televisions to be placed almost anywhere. Television stands are generally provided with a single base with an extension that attaches to the bottom of the television at the center. Most televisions will come packaged with their customized bases. As a space saving means, many consumers moved towards the wall mounts. However, as technology continued to advance, the television screens became larger and larger, increasing the instability of the televisions. Therefore, consumers may want to have the option of mounting their televisions on the wall, or having the television rest on a stand. However, moving back to the stand requires that the consumer still has and can find the original base.

Therefore, there is a need for new monitor stands that provide improved stability and versatility, while maintaining its own compactness to allow the user to move any television from a wall mount to a stand and back again with minimal effort without requiring the original stand or base the television may have come with.

### SUMMARY

The present invention is directed to a universal stand that can connect to most flat screen monitors while providing improved stability and versatility. A monitor is broadly defined to include any screen capable of displaying still or animated pictures and information, such as, but not limited to televisions, computer monitors, screens and the like. The universal stand comprises a foot, a leg attached to the foot, and a bracket attached to the leg. The bracket is attachable to a flat screen monitor. In the preferred embodiment, the universal stand comprises a pair of feet, a pair of legs, each leg attached to one foot, and a pair of brackets attached to a monitor, each bracket attached to one leg.

### BRIEF DESCRIPTION OF DRAWINGS

FIG. 1 shows a perspective view of an embodiment of the present invention.

FIG. 2 shows a front view of the embodiment shown in FIG. 1.

FIG. 3 shows a side view of the embodiment shown in FIG. 1.

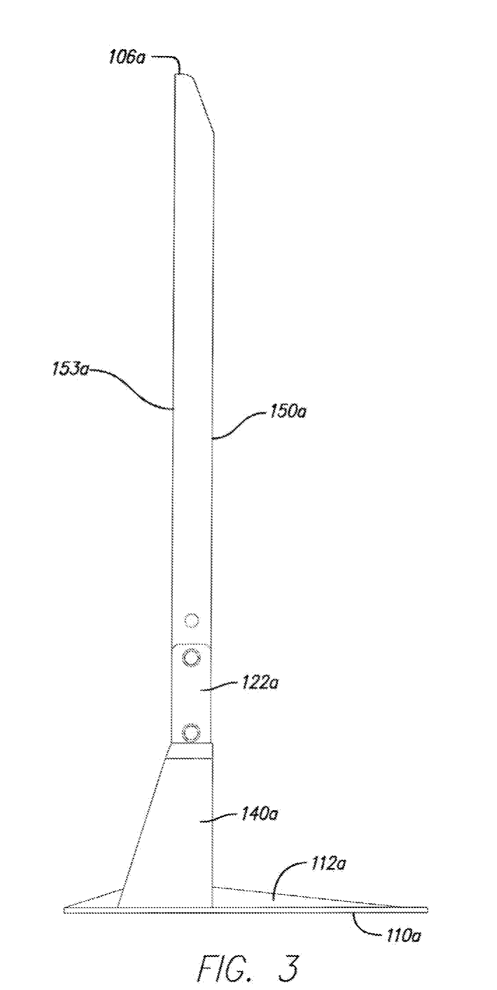

FIG. 4 shows an exploded view of the embodiment shown in FIG. 1.

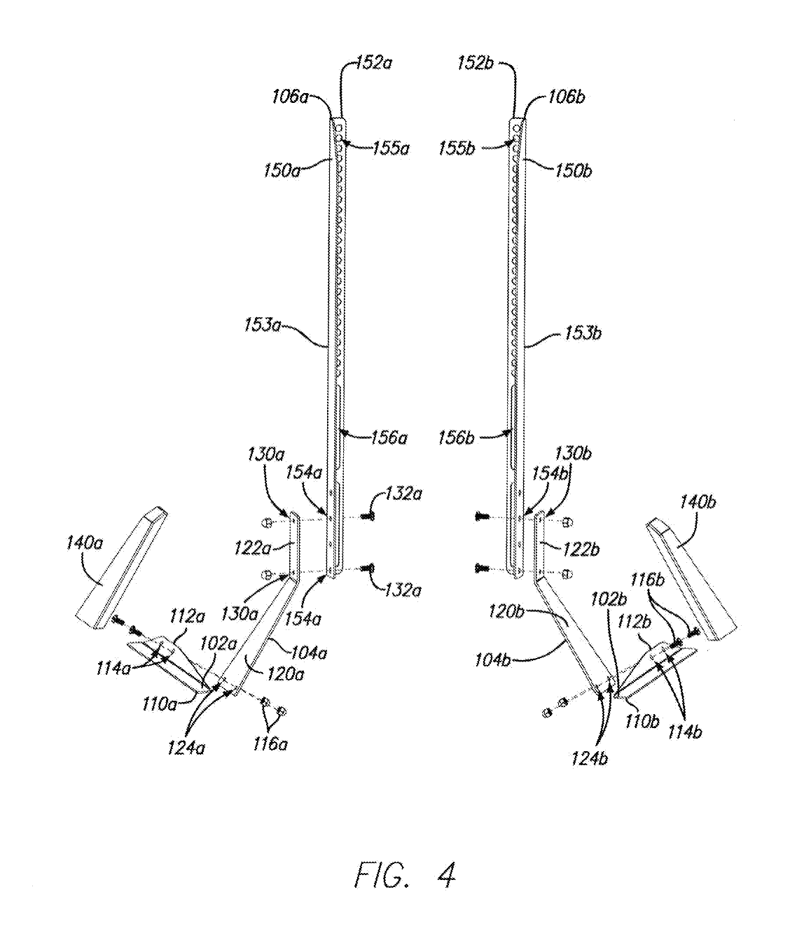

FIG. 5 shows rear view of the embodiment shown in FIG. 1 in use.

### DETAILED DESCRIPTION OF THE INVENTION

The detailed description set forth below in connection with the appended drawings is intended as a description of presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

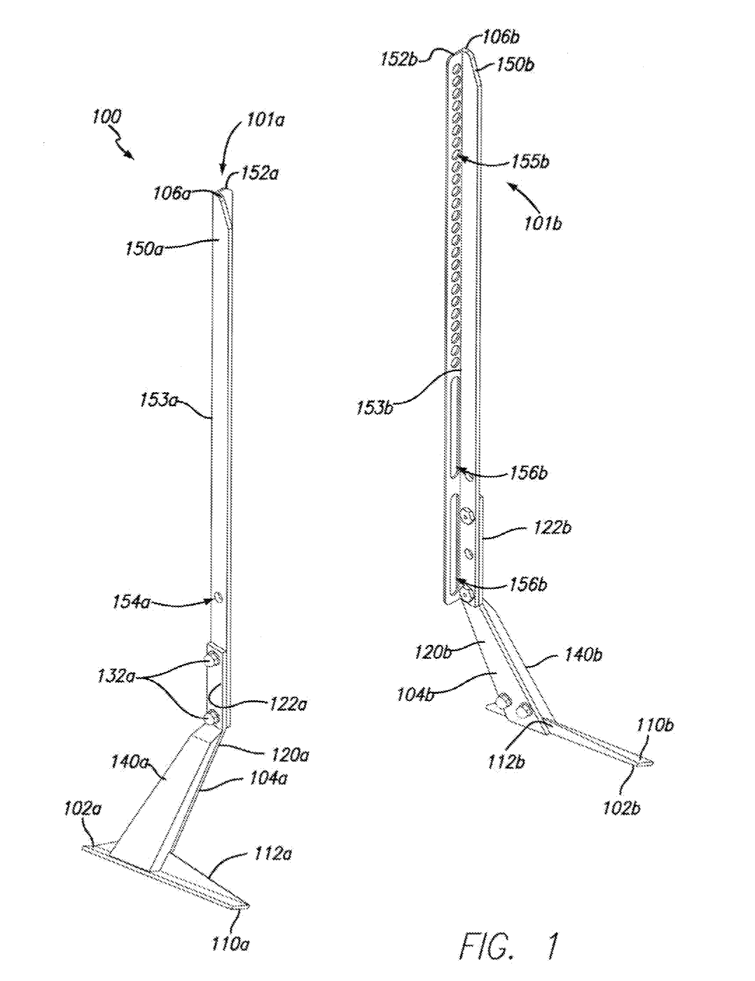

As shown in FIG. 1, a universal stand 100 for flat screen monitors comprises a foot 102a, a leg 104a, and a bracket 106a. The foot 102a provides the foundational base to support the bracket 106a. The leg 104a is an angled bar that connects the foot 102a to the bracket 106a so that the bracket 106a is in the proper orientation. The bracket 106a attaches to monitor so that the monitor can be supported by the foot 102a.

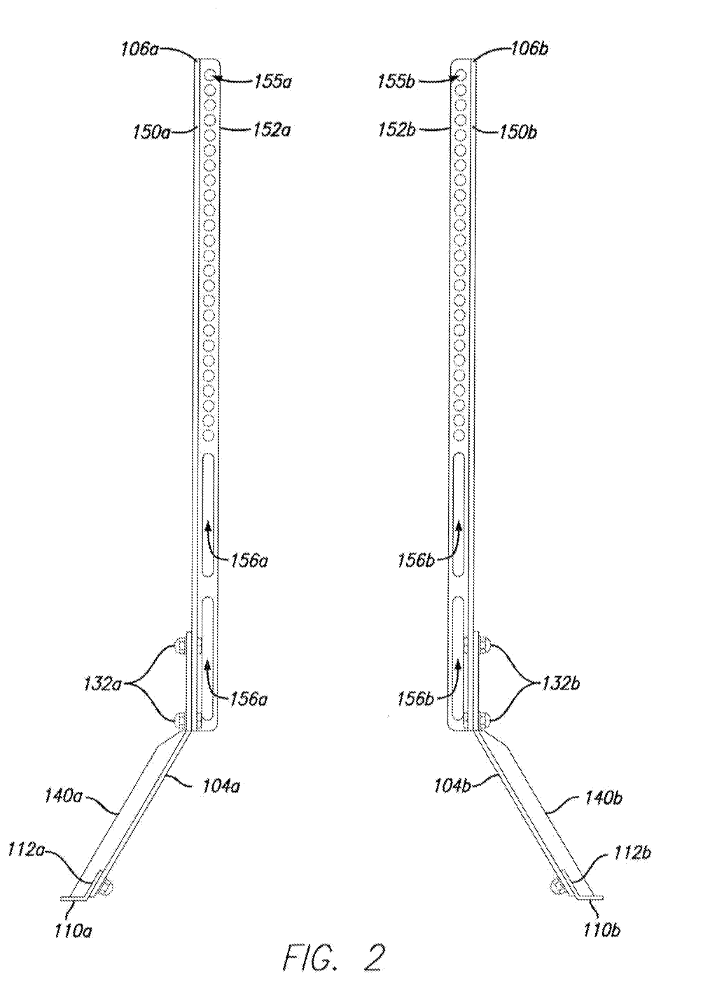

As shown in FIG. 2, the foot 102a comprises a base 110a and a wall 112a, the base 110a and wall 112a forming an obtuse angle. The base 110a provides a flat surface to rest on a floor, table, stand, desk, and the like. The wall 112a comprises one or more holes 114a through which fasteners 116a can be used to secure the leg 104a to the foot 102a. The base 110a and wall 112a may be formed as a single, integrally formed unit, or two separate pieces fastened together. In the preferred embodiment, the base 110a is generally rectangular in shape having opposing short sides, and opposing long sides. The wall 112a is generally trapezoidal in shape, having parallel top and bottom edges, with the bottom edge being longer than the top edge, and non-parallel side edges. The bottom edge of the wall 112a is attached to or integrally formed with one of the long sides of the base 110a.

The leg 104a may be a flattened bar having a lower portion 120a and an upper portion 122a, wherein the lower portion 120a and upper portion 122a form an obtuse angle. The lower portion 120a and upper portion 122a may be integrally formed as a single piece, or two separate pieces connected together.

In the preferred embodiment, the lower portion 120a is generally trapezoidal in shape, having a lower edge and an upper edge opposite and parallel to the lower edge, and opposing, non-parallel side edges. The side edges taper so that the upper edge is shorter than the lower edge. Adjacent to or near the lower edge are holes 124a opposite the upper portion 122a, so that the lower portion 120a can be fastened to the foot 102a. In particular, the holes 124a of the lower portion 120a of the leg 104a can align with the holes 114a of the foot 102a allowing the lower portion 120a of the leg 104a and the foot 102a to be fastened together with a fastener 116a. Due to the bent configuration of the foot 102a and the leg 104a, this connection causes the upper portion 122a of the leg 104a to be perpendicular to the base 110a of the foot 102a.

The upper portion 122a is generally rectangular in shape having a pair of short sides and a pair of long sides, each pair of short sides being adjacent to the long sides. One of the short sides is attached to or integrally formed with the upper edge of the lower portion 120a. The upper portion 122a also comprises a means for fastening the upper portion 122a to the bracket 106a. In the preferred embodiment, the upper portion 122a comprises holes 130a through which a fastener 132a can be used to secure the bracket 106a to the leg 104a.

In some embodiments, the connection between the base 102a and the leg 104a, or the connection between the leg 104a and the bracket 106a may be configured so that the two respective pieces mate with each other via rails, tongue and groove, snaps, and the like. Nuts and bolts, screws, nails, rivets, and the like can also be used to farther secure the connection.

In some embodiments, a cover 140a can be attached to the leg 104a, or a portion of the leg 104a, to hide the fasteners 116a, 132a and/or for aesthetic appeal. The cover 140a may be made of plastic or any other material to cover at least a portion of the leg 104a. Preferably, the cover 140a can be secured on to the leg 104a without the use of any additional tools, for example, by using a snap-fit, resistance fit, tongue and groove, magnets, and the like.

The bracket 106a is an elongated sturdy structure that can be fastened to the television at one portion and the leg 104a at another portion. The bracket 106a is formed as an elongated angle. Therefore, one elongated bar 150a of the bracket 106a forms approximately a right angle with a second elongated bar 152a of the bracket 106a, at what will be referred to as a centerline 153a, preferably along the entire length of the bracket 106a. The first elongated bar 150a may comprise a plurality of holes 154a at the lower end of the bracket 106a so as to be eonnectabie to the leg 104a, preferably, at the upper portion 122a of the leg 104a. The holes 154a can align with the holes 130a to receive a fastener. This connection allows the remaining portions of the bracket 106a to be free for attachment to the back of a flat screen monitor 10.

Along the length of the second elongated bar 152a is a plurality of holes 155a and/or slots 156a. These holes 155a and/or slots 156a allow the bracket 106a to be connected to a variety of flat screen monitors through the use of bolts and/or screws. Most flat screen monitors come preconfigured with a plurality of threaded holes so as to be mounted on a frame. Due to the number and positioning of the holes 155a and/or slots 156a, at least one of the holes 155a and/or slot 156a will align with at least one of the threaded holes on almost any flat screen monitor. Preferably, at least two of the holes 155a and/or slots 156a will align with at least two threaded holes on the monitor.

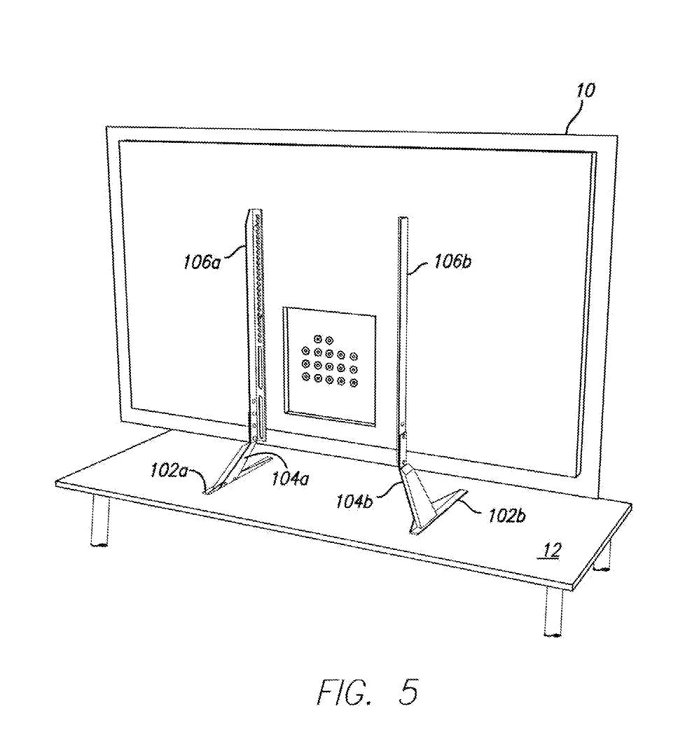

Each component can be duplicated identically or created as mirror images to create a pair of feet 102a, 102b, a pair of legs 104a, 104b, and a pair of brackets 106a, 106b to be mounted bilaterally on the back of a flat screen monitor as shown in FIG. 5. Therefore, like the first foot 102a, the second foot 102b comprises a base 110b and a wall 112b with holes 114b through which fasteners 116b can be used, as described above for the first foot 102a. and incorporated here by this reference.

Similarly, like the first leg 104a, the second leg 104b comprises a lower portion 120b, an upper portion 122b, and a plurality of holes 124b, 130b, or other fastening system to fasten to the foot 102b or bracket 106b as described above for the first leg 104a and incorporated here by this reference. In some embodiments, a cover 140b can be attached to the leg 104b to hide the fasteners 116b and/or for aesthetic appeal.

The bracket 106b may also comprise a first elongated bar 150b and a second elongated bar 152b forming approximate right angles with each other at a centerline 153b, preferably along the entire length of the bracket 106b, with a plurality of holes 154b at the lower end of the bracket 106b to attach to a leg 104b, and a plurality of holes 155b, and/or slots 156b to attach to a monitor as described above for the first bracket 106a and incorporated here by this reference.

All materials may be made of hard rigid material such as plastic, metal, wood, and the like.

By way of example only, in use, a flat screen monitor 10 may be placed on a surface 12 elevated off of the ground with the back side of the monitor 12 facing up. The second elongated bar 152a of a first bracket 106a may be placed flush against the back side of the monitor and moved around until the desired threaded hole on the monitor aligns with one of the holes 155a or slot 156a of the first bracket 106a. For better securement, a second threaded hole on the monitor should be aligned with another hole 155a or slot 156a on the first bracket 106c. This process can be repeated with the second bracket 106b to secure the second bracket 106b opposite, but aligned parallel with the first bracket 106a. Preferably, the two brackets 106a, 106b are equidistant from the center of the monitor 10.

The upper portion 122a of die first leg 104a can be positioned so as to align the holes 130a with the holes 154a of the first bracket 106a and secured using fasteners 132a. This process can be repeated to connect the second leg 104b to the second bracket 106b.

The wall 112a of the first foot 102a can be positioned against the lower portion 120a of the first leg 104a to align holes 114a with the holes 124a on the first leg 104a and secured using fasteners 116a. This process can be repeated to connect the second leg 104b to the second foot 102b. Covers 140a, 140b, if desired, can be placed on the lower portions 120a, 120b of their respective legs 104a, and 104b. The assembly of the components, i.e. feet 102a, 102b, legs 104a, 104b, brackets 106a, 106b, and covers 140a, 140b can be done in any logical order.

Once mounted properly, due to a first obtuse angle created in the feet 102a, 102b, and a second obtuse angle created in the legs 104a, 104b, the feet 102a, 102b are offset from rise centerlines 153a, 153b, of their respective brackets 106a, 106b. In other words, the feet 102a, 102b are not positioned directly under their respective brackets 106a, 106b. Therefore, the distance between the feet 102a, 102b is greater than the distance between the brackets 106a, 106b. Nearly any flat screen monitor can be mounted on the stand of the present invention without the need of the original stand.

Variations to the universal monitor stand 100 include features to improve the versatility or adjustability of the stand 100. For example, to improve the adjustability of the height. For example, rather than adjusting the TV to fit different holes 155a, 155b and/or slots 156a, 156b, or adjusting the legs 104a, 104b to attach higher or lower on the brackets 106a, 106b, the brackets 106a, 106b may be extendable. For example, each bracket 106a, 106b may be made of two pieces that can slide along their respective centerlines 153a, 153b (i.e. telescopic action) and locked into a new position.

Similarly, to adjust, the forward/backward stability of the TV, the feet 102a, 102b may be extendable in the forward/backward direction. This can be done by making the feet 102a, 102b telescoping or by attaching extensions to the feet 102a, 102b in the forward or backward direction.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A universal flat screen TV stand, comprising:
a. a pair of feet, each foot comprising;
i. a base, and
ii. an angled wall forming a first obtuse angle with the base;
b. a pair of legs, each leg connectable to one of the feet, each leg comprising
i. a lower portion, and
ii. an upper portion, the lower and upper portions forming a second obtuse angle;
c. a pair of brackets, each bracket connectable to one of the legs and configured to attach to a monitor, each bracket comprising an angled bar, each angled bar having:
i. a first elongated bar;
ii. a second elongated bar connected to the first elongated bar to form a right angle, the first and second elongated bars defining a length of their respective brackets,
iii. a plurality of holes defined along the length of a first portion of the first elongated bar, and
iv. at least one slot defined along a second portion of the first elongated bar; and
d. a pair of covers, one cover to conceal at least a portion of each leg.

2. A universal flat screen TV stand, comprising:
a. a pair of feet;
b. a pair of legs, each leg connected to one of the feet; and
c. a pair of brackets, each bracket connected to one of the legs and configured to attach to a monitor.

3. The TV stand of claim 2, wherein each pair of feet comprises:
a. a base, and
b. an angled wall forming an obtuse angle with the base.

4. The TV stand of claim 2, wherein each leg comprises;
a. a lower portion; and
b. an upper portion forming an obtuse angle with the lower portion.

5. The TV stand of claim 4, further comprising a pair of covers, one cover to conceal at least a portion of each leg.

6. The TV stand of claim 2, wherein each bracket comprises an angled bar, each angled bar having:
a. a first elongated bar;
b. a second elongated bar keep to the first elongated bar to form a right angle, the first and second elongated bars defining a length of their respective brackets.

7. The TV stand of claim 6, wherein the bracket further comprises:
a. a plurality of holes defined along the length of a first portion of the first elongated bar; and
b. at least one slot defined along a second portion of the first elongated bar.

8. A universal flat screen TV stand, comprising:
a. a foot;
b. a leg eonnectabie to the foot; and
c. a bracket connectable to the leg and configured to attach to a monitor,
d. wherein each bracket is connectable to one of the legs.

9. The TV stand of claim 8, wherein each pair of feet comprises:
a. a base, and
b. an angled wall forming an obtuse angle with the base.

10. The TV stand of claim 8, wherein each leg comprises:
a. a lower portion; and
b. an upper portion forming an obtuse angle with the lower portion.

11. The TV stand of claim 10, further comprising a pair of covers, one cover to conceal at least a portion of each leg.

12. The TV stand of claim 8, wherein each bracket comprises an angled bar, each angled bar having:
a. a first elongated bar;
b. a second elongated bar connected to the first elongated bar to form a right angle, the first and second elongated bars defining a length of their respective brackets.

13. The TV stand of claim 12, wherein the bracket further comprises:
a. a plurality of holes defined along the length of a first portion of the first elongated bar; and
b. at least one slot defined along a second portion of the first elongated bar.
